(19) United States
(12) Patent Application Publication
(10) Pub. No.: US 2016/0141131 A1
(43) Pub. Date: May 19, 2016

(54) CONNECTION STRUCTURE OF ELECTRONIC COMPONENT AND TERMINAL METAL FITTINGS

(71) Applicant: Yazaki Corporation, Tokyo (JP)

(72) Inventor: Yukihiro KAWAMURA, Shizuoka (JP)

(73) Assignee: Yazaki Corporation, Tokyo (JP)

(21) Appl. No.: 15/003,186

(22) Filed: Jan. 21, 2016

Related U.S. Application Data
(63) Continuation of application No. PCT/JP2014/072270, filed on Aug. 26, 2014.

(30) Foreign Application Priority Data
Aug. 30, 2013 (JP) 2013-179117

(51) Int. Cl. H01H 50/14; H01H 50/04

(52) U.S. Cl. CPC H01H 50/14; H01H 50/04

(57) ABSTRACT

A connection structure of an electronic component and terminal metal fittings includes a relay including a relay body and a plurality of terminals, terminal metal fittings mating with the terminals, and a holding member. The terminals have end portions facing side surfaces of the relay body, and their leading ends are positioned closer to a top surface side than a bottom surface of the relay body. At a side surface, a first terminal and a second terminal that is more rigid than the first terminal are disposed. The holding member includes a component body accommodating portion, a first terminal accommodating portion, and a second terminal accommodating portion. A gap dimension between the first terminal and an insertion slot of the first terminal accommodating portion is larger than a gap dimension between the second terminal and an insertion slot of the second terminal accommodating portion.

### CROSS-REFERENCE TO RELATED APPLICATION

This application is a continuation application of International Application PCT/JP2014/072270, filed on Aug. 26, 2014, and designating the U.S., the entire contents of which are incorporated herein by reference.

### BACKGROUND OF THE INVENTION

1. Field of the Invention

The present invention relates to a connection structure of an electronic component and terminal metal fittings.

2. Description of the Related Art

FIG. 7 is a perspective view of a conventional relay. FIG. 8 is a bottom view of the relay illustrated in FIG. 7. FIG. 9 is a sectional view of a connection structure of the relay illustrated in FIG. 7 and terminal metal fittings. For the convenience of illustration, FIG. 9 illustrates a relay body 302 only in a side view.

As illustrated in FIGS. 7 and 8, this conventional relay 301 includes the relay body 302 having a rectangular parallelepiped outer shape, and a plurality of plate-like terminals 303a and 303b protruding from a bottom surface 302b of the relay body 302 to mate with terminal metal fittings 304 (illustrated in FIG. 9).

The terminals 303a conduct electric current to a coil inside the relay body 302. The terminals 303b are terminals to which a higher voltage or a larger current than the terminals 303a is applied. The terminals 303b have a larger width and thickness than the terminals 303a.

As illustrated in FIG. 9, a connection structure 307 of the conventional relay and the terminal metal fittings includes the relay 301 illustrated in FIGS. 7 and 8, the terminal metal fittings 304 mating with the terminals 303a and 303b of the relay 301, and a holding member 306 to which the relay 301 and the terminal metal fittings 304 are mounted. The terminal metal fittings 304 are connected to end portions of wires 305.

The holding member 306 is made of a synthetic resin. The holding member 306 includes a plurality of accommodating portions 361 for accommodating the terminals 303a and 303b and the terminal metal fittings 304, and lances 362 provided in the accommodating portions 361 to engage the terminal metal fittings 304.

Japanese Patent Application Laid-open No. 2010-221787 discloses an electrical connection box for automobiles that has the connection structure 307 of the relay and the terminal metal fittings described above.

The conventional connection structure 307 of the relay and the terminal metal fittings fails to allow the terminals 303a and 303b to enter the corresponding accommodating portions 361 in a straight position, not in a sloping position, when the relay 301 is attached to the holding member 306. This situation may cause distortion or damage to the terminals 303a and 303b in some cases. In particular, the terminals 303a, which are less rigid than the terminals 303b, are more likely to suffer distortion or damage.

The terminals 303a of the relay 301 differ from the terminals 303b in rigidity by their different width and thickness. Some other relays include a plurality of terminals that have different rigidity by their different materials. Such relays may also suffer distortion or damage to their less rigid terminals as in the case of the relay 301.

A connection structure of an electronic component other than the relay 301 and terminal metal fittings may cause distortion or damage to the terminals if the electronic component is attached to the holding member with its inclined posture.

### SUMMARY OF THE INVENTION

It is an object of the present invention to provide a connection structure of an electronic component and terminal metal fittings that can prevent distortion or damage to terminals of the electronic component when the electronic component is attached to a holding member.

In order to achieve the above mentioned object, a connection structure of an electronic component and terminal metal fittings according to one aspect of the present invention includes an electronic component including a component body having a rectangular parallelepiped outer shape, and a plurality of terminals that have end portions facing side surfaces of the component body, the end portions having leading ends positioned closer to a top surface side than a bottom surface of the component body; a plurality of terminal metal fittings configured to mate with the corresponding terminals; and a holding member in which the electronic component and the plurality of terminal metal fittings are accommodated, wherein two or more terminals of the terminals facing a side surface of the component body include a first terminal and a second terminal that is more rigid than the first terminal, the holding member includes a component body accommodating portion that accommodates the component body, and terminal accommodating portions that accommodate the end portions of the terminals and the terminal metal fittings, and a gap dimension between the first terminal and an insertion slot of a first terminal accommodating portion in which the first terminal is accommodated is larger than a gap dimension between the second terminal and an insertion slot of a second terminal accommodating portion in which the second terminal is accommodated.

According to another aspect of the present invention, in the connection structure, it is desirable that the plurality of terminals protrude from the component body and bend in right angles.

According to still another aspect of the present invention, in the connection structure, it is desirable that a width of the second terminal is formed larger than a width of the first terminal.

According to still another aspect of the present invention, in the connection structure, it is desirable that the second terminal is made of a material that is more rigid than a material of the first terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view of a connection structure of an electronic component and terminal metal fittings according to an embodiment of the present invention;

FIG. 2 is a perspective view of a relay illustrated in FIG. 1;

FIG. 3 is a bottom view of the relay illustrated in FIG. 2;

FIG. 4 is a sectional view of a holding member illustrated in FIG. 1;

FIG. 5 is a sectional view taken along line A-A in FIG. 1;

FIG. 6 is a diagram illustrating how the relay illustrated in FIG. 1 is inserted into the holding member;

FIG. 7 is a perspective view of a conventional relay;

FIG. 8 is a bottom view of the relay illustrated in FIG. 7; and

FIG. 9 is a sectional view of a connection structure of the relay illustrated in FIG. 7 and terminal metal fittings.

### DETAILED DESCRIPTION OF THE PREFERRED EMBODIMENTS

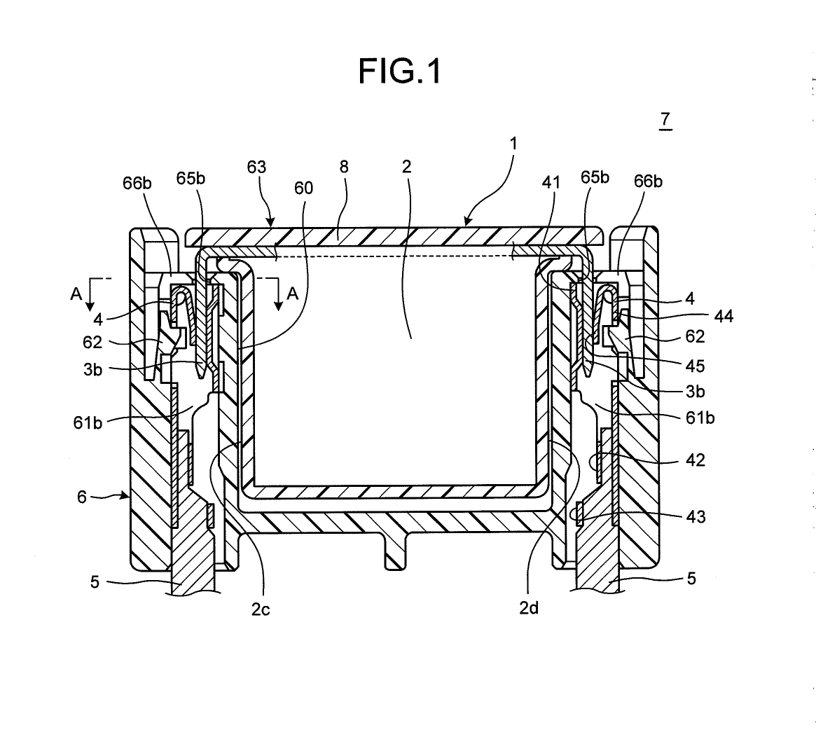

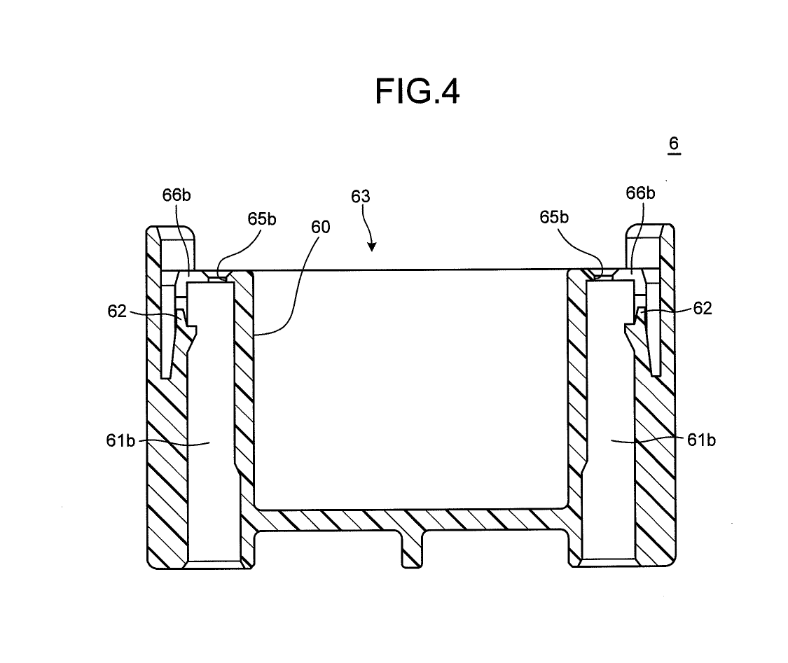

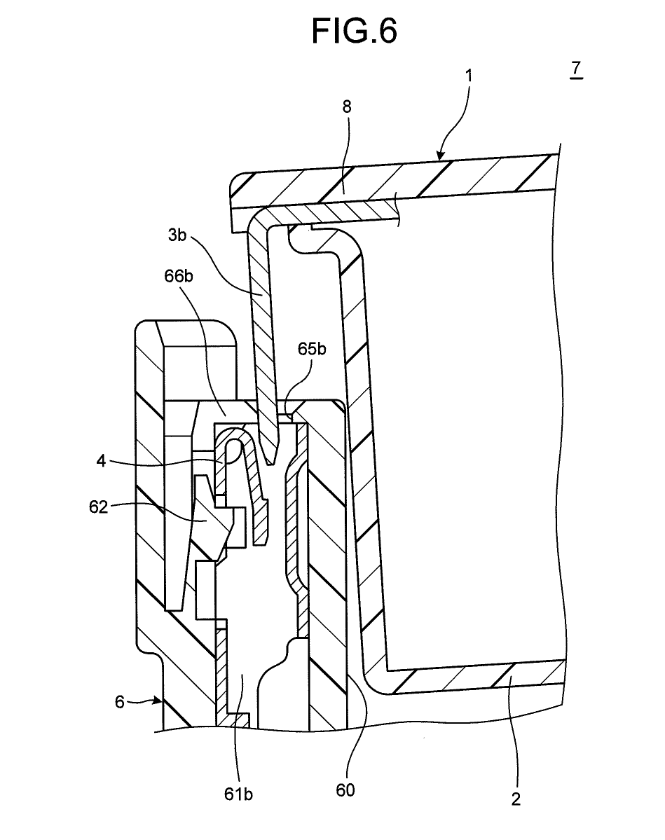

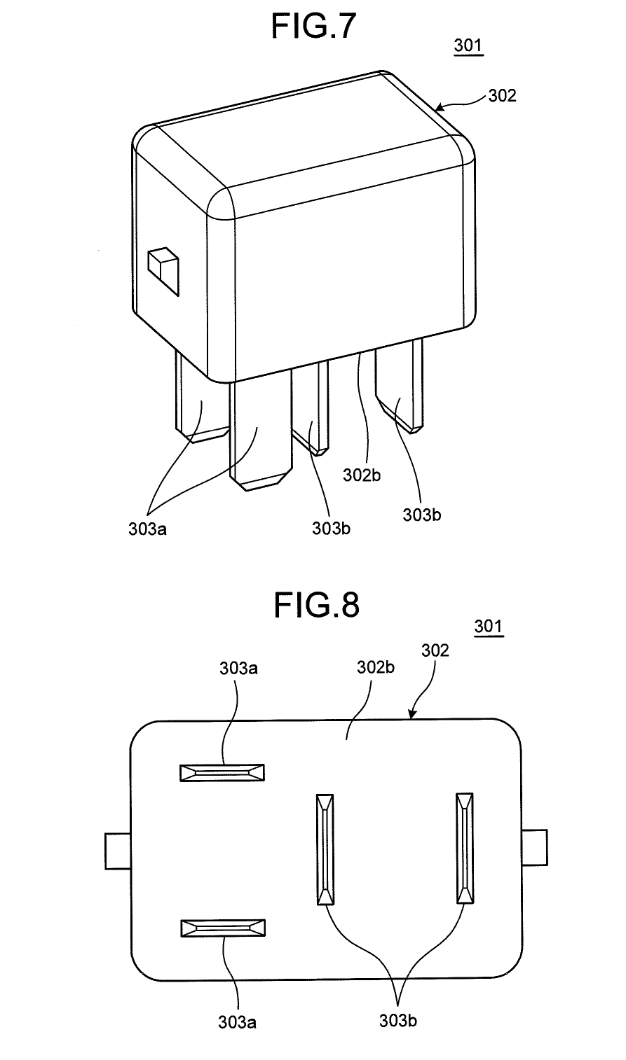

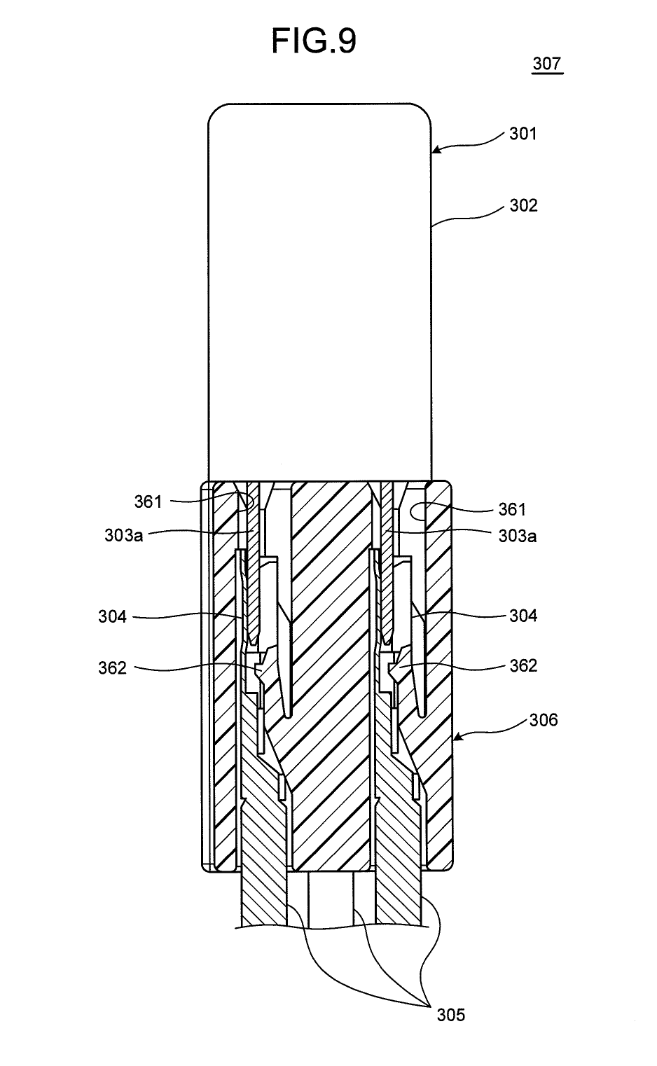

The following describes a “connection structure of an electronic component and terminal metal fittings” according to an embodiment of the present invention with reference to FIGS. 1 to 6. A connection structure 7 of an electronic component and terminal metal fittings illustrated in FIG. 1 is used for, for example, an electrical connection box for automobiles. The connection structure 7 of an electronic component and terminal metal fittings includes a relay 1 (“electronic component” in Claims) including a relay body 2 (“component body” in Claims) having a rectangular parallelepiped outer shape and a plurality of terminals 3a and 3b protruding from the relay body 2, a plurality of terminal metal fittings 4 mating with the corresponding terminals 3a and 3b, and a holding member 6 that accommodates the relay 1 and the terminal metal fittings 4. FIGS. 1 and 6 omit drawings of various parts accommodated inside the relay body 2. FIGS. 1 and 4 are sectional views taken along the longitudinal direction of two terminal accommodating portions 61b to be described later.

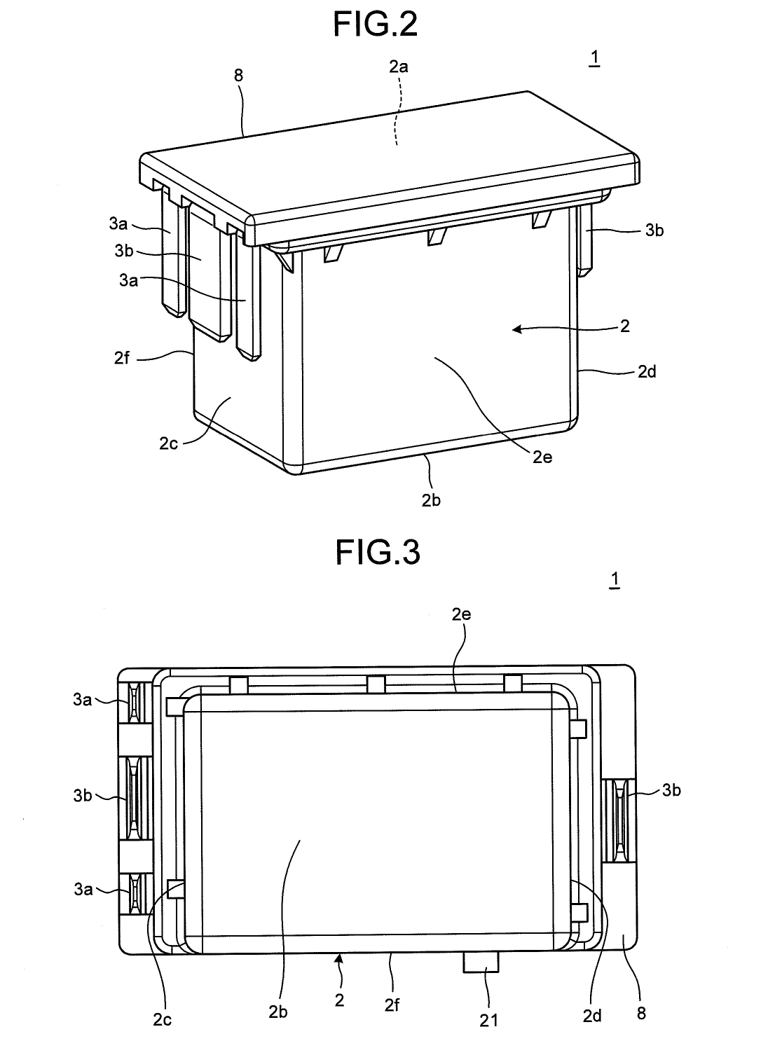

As described above, the relay 1 includes the relay body 2 having a rectangular parallelepiped outer shape. As illustrated in FIGS. 2 and 3, the relay body 2 has a top surface 2a and a bottom surface 2b facing each other, side surfaces 2c and 2d facing each other, and side surfaces 2e and 2f facing each other. As illustrated in FIG. 3, the side surface 2f has an engaging protrusion 21 that engages the holding member 6. The relay 1 includes a plate-like resin member 8 that holds the terminals 3a and 3b and is mounted on the top surface 2a. The resin member 8 holds the terminals 3a and 3b by insert molding or engaging structure.

The terminals 3a and 3b are made of metal plate and are held by the resin member 8 as described above. Base portions of the terminals 3a and 3b are electrically connected to a conductor inside the relay body 2. Middle portions of the terminals 3a and 3b are bent on a surface of the resin member 8 at right angles toward the bottom surface 2b of the relay body 2. End portions of the terminals 3a and 3b face the side surfaces 2c and 2d. The end portions of the terminals 3a and 3b mate with connection parts 41 of the terminal metal fittings 4 to be described later. The leading ends of the terminals 3a and 3b are positioned closer to the top surface 2a side than the bottom surface 2b of the relay body 2.

The terminals 3a and 3b are four terminals in total, three of which face the side surface 2c and the remaining one of which faces the side surface 2d. Specifically, two terminals 3a and a terminal 3b face the side surface 2c and the remaining terminal 3b face the side surface 2d. The two terminals 3a facing the side surface 2c are disposed at both sides of the terminal 3b. All the leading ends of the terminals 3a and 3b are aligned along the same height position.

The terminals 3a are terminals that energize a coil inside the relay body 2, and the terminals 3b are terminals to which a higher voltage or a larger current than that of the terminals 3a is applied. Hereinafter, the terminals 3a are referred to as first terminals 3a and the terminals 3b are referred to as second terminals 3b. The second terminals 3b have a larger width and thickness than those of the first terminals 3a. With this configuration, the second terminals 3b are more rigid than the first terminals 3a.

The terminal metal fittings 4 are made by, for example, presswork on a metal plate, and are connected to the corresponding ends of wires 5. Each terminal metal fitting 4 includes a female connection part 41 that mates with the terminal 3a or 3b, a crimping piece 42 that caulks the core wire uncovered from insulating coating and exposed at an end portion of a wire 5, and a crimping piece 43 that caulks a portion covered by the insulating coating (FIG. 1). The connection part 41 includes a pipe portion 44 in which the terminal 3a or 3b is positioned, and a spring 45 that presses inward the terminal 3a or 3b positioned in the pipe portion 44. In the context of the present invention, other terminal metal fittings than the terminal metal fittings 4 can also be used, such as terminal metal fittings having a Faston shape or terminal metal fittings having a tuning-fork shape.

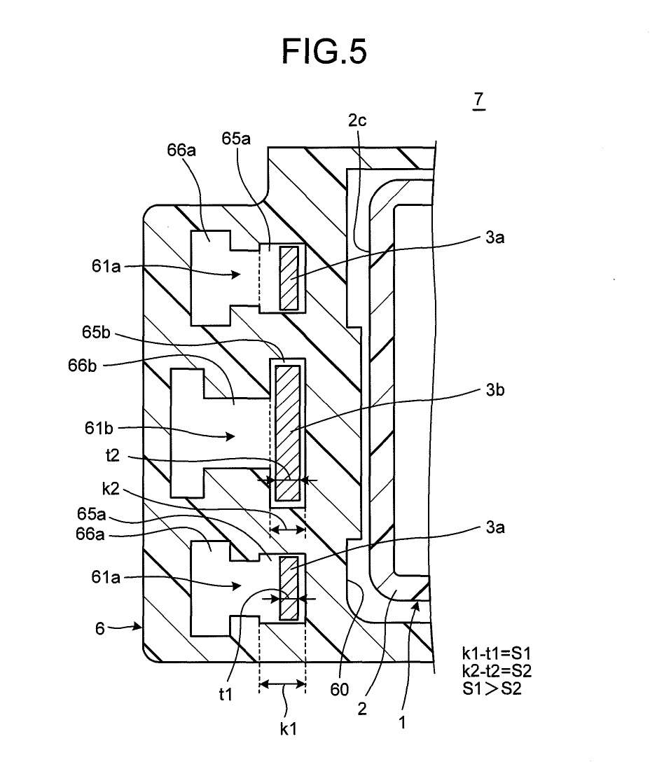

The holding member 6 is made of a synthetic resin. The holding member 6 includes one or more relay accommodating portions 63 and engaging portions (not illustrated) that engage a case of a component such as the electrical connection box. As illustrated in FIGS. 4 and 5, such a relay accommodating portion 63 includes a component body accommodating portion 60 that accommodates the relay body 2, terminal accommodating portions 61a and 61b that accommodate the end portions of the terminals 3a and 3b and the terminal metal fittings 4, and lances 62 provided in the terminal accommodating portions 61a and 61b to engage the terminal metal fittings 4. The component body accommodating portion 60 has a recessed shape opening upward. The terminal accommodating portions 61a and 61b have a pipe-like shape opening both upward and downward. In this context, the word “downward” indicates the direction in which the relay 1 is inserted into the holding member 6. The word “upward” indicates the direction opposite to the inserting direction.

Hereinafter, the terminal accommodating portions 61a that accommodate the first terminals 3a are referred to as first terminal accommodating portions 61a. The terminal accommodating portions 61b that accommodate the second terminals 3b are referred to as second terminal accommodating portions 61b. The first terminals 3a are inserted into the first terminal accommodating portions 61a through insertion slots 65a illustrated in FIG. 5. Openings 66a in FIG. 5 are holes through which metal molds that mold the lances 62 were removed. Each insertion slot 65a is connected to a corresponding opening 66a. In the same manner, the second terminals 3b are inserted into the second terminal accommodating portions 61b through insertion slots 65b illustrated in FIGS. 4 and 5. Openings 66b in FIGS. 4 and 5 are holes through which metal molds that mold the lances 62 were removed. Each insertion slot 65b is connected to a corresponding opening 66b.

As illustrated in FIG. 5, a gap dimension S1 in the terminal thickness direction between the first terminal 3a and the insertion slot 65a of the first terminal accommodating portion 61a is larger than a gap dimension S2 in the terminal thickness direction between the second terminal 3b and the insertion slot 65b of the second terminal accommodating portion 61b. The “gap dimension S1 in the terminal thickness direction” is defined by subtracting a terminal thickness t1 of the first terminal 3a from a dimension k1 of the insertion slot 65a of the first terminal accommodating portion 61a in the terminal thickness direction. The “gap dimension S2 in the terminal thickness direction” is defined by subtracting a terminal thickness t2 of the second terminal 3b from a dimension k2 of the insertion slot 65b of the second terminal accommodating portion 61b in the terminal thickness direction.

The connection structure 7 of such an electronic component and terminal metal fittings is assembled such that, first, the terminal metal fittings 4 are connected to the end portions of the wires 5, and then the wires 5 with the terminal metal fittings are inserted into the first terminal accommodating portions 61a and the second terminal accommodating portions 61b from the bottom to cause the terminal metal fittings 4 to engage the lances 62. Subsequently, the relay 1 is inserted into the relay accommodating portion 63 of the holding member 6 from above to cause the terminals 3a and 3b to mate with the corresponding terminal metal fittings 4, thus completing the connection structure 7.

As illustrated in FIG. 6, the relay 1 is inserted into the relay accommodating portion 63 such that the relay body 2 enters the component body accommodating portion 60 before the terminals 3a and 3b enter the terminal accommodating portions 61a and 61b. This configuration roughly determines the positions of the terminals 3a and 3b relative to the corresponding terminal accommodating portions 61a and 61b. Thus, the connection structure 7 can prevent distortion or damage to the terminals 3a and 3b when the relay 1 is attached.

As described above, the connection structure 7 has the gap dimension S1 in the terminal thickness direction between the first terminal 3a and the insertion slot 65a of the first terminal accommodating portion 61a that is larger than the gap dimension S2 in the terminal thickness direction between the second terminal 3b and the insertion slot 65b of the second terminal accommodating portion 61b. This configuration prevents the first terminal 3a from hitting a nearby surface around the insertion slot 65a of the first terminal accommodating portion 61a if the second terminal 3b hits a nearby surface around the insertion slot 65b of the second terminal accommodating portion 61b. In other words, the connection structure 7 allows the second terminal 3b and the insertion slot 65b of the second terminal accommodating portion 61b to serve as a guide for the first terminal 3a to be inserted into the insertion slot 65a of the first terminal accommodating portion 61a. Thus, the connection structure 7 can more securely protect the first terminal 3a that is less rigid than the second terminal 3b.

As described in Claims, a “gap dimension between the first terminal and an insertion slot of a first terminal accommodating portion” and a “gap dimension between the second terminal and an insertion slot of a second terminal accommodating portion” include dimensions in two directions that are the “gap dimensions (which are the gap dimensions S1 and S2) in the terminal thickness direction” and “gap dimensions in the terminal width direction”. In the context of the present invention, gap dimensions in at least one direction of the two directions meet the condition described above.

In the above embodiment, the first terminals 3a differ from the second terminals 3b in rigidity by their different width and thickness. In some embodiments, the present invention includes first terminals and second terminals that have the same thickness but have different widths. In other embodiments, the present invention includes first terminals and second terminals that have different rigidity by their different materials, not by their sizes. For example, the second terminals are made of a material that is more rigid than the material of the first terminals.

Although, in the above embodiment, the two first terminals 3a and one second terminal 3b face the side surface 2c of the relay body 2, at least one first terminal and at least one second terminal face a side surface of the relay body in the present invention. Although, in the above embodiment, the two first terminals 3a are disposed at both sides of a second terminal 3b, the arrangement order of the first terminals 3a and the second terminal 3b is not limited to this in the present invention. For example, the second terminal 3b may be disposed in an endmost position, not in the center position.

The above embodiment is presented in a representative form of the present invention, and thus, is not intended to limit the scope of the present invention. In other words, the connection structure 7 according to the present invention may be modified in various other forms without departing from the scope of the present invention.

The connection structure according to the present invention includes a plurality of terminals (for example, terminals protruding from the component body and bending at right angles) having end portions facing side surfaces of the component body, and the leading ends of the end portions are positioned closer to the top surface than the bottom surface of the component body. This configuration allows the component body to enter the component body accommodating portion before the terminals enter the terminal accommodating portions when the electronic component is attached to the holding member, and the positions of the terminals are roughly determined relative to the corresponding terminal accommodating portions. Thus, this connection structure can prevent distortion or damage to the terminals when the electronic component is attached. The connection structure has a larger gap dimension between the first terminal and the insertion slot of the first terminal accommodating portion that accommodates the first terminal than a gap dimension between the second terminal and the insertion slot of the second terminal accommodating portion that accommodates the second terminal. This configuration prevents the first terminal from hitting a nearby surface around the insertion slot of the first terminal accommodating portion if the second terminal hits a nearby surface around the insertion hole of the second terminal accommodating portion. Thus, the connection structure can more securely protect the first terminal that is less rigid than the second terminal.

The connection structure may include the second terminal having a larger width than a width of the first terminal, which protects, in particular, the first terminal. This configuration allows the first and the second terminals to have most suitable sizes for the voltage values and current values to be applied to the respective terminals.

The connection structure may include the second terminal made of a material more rigid than a material of the first terminal, which protects, in particular, the first terminal. This configuration allows the first and the second terminals to be composed of most suitable materials for the voltage values and current values to be applied to the respective terminals.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection structure of an electronic component and terminal metal fittings, comprising:
an electronic component including a component body having a rectangular parallelepiped outer shape, and a plurality of terminals that have end portions facing side surfaces of the component body, the end portions having leading ends positioned closer to a top surface side than a bottom surface of the component body;
a plurality of terminal metal fittings configured to mate with the corresponding terminals; and
a holding member in which the electronic component and the plurality of terminal metal fittings are accommodated, wherein
two or more terminals of the terminals facing a side surface of the component body include a first terminal and a second terminal that is more rigid than the first terminal,
the holding member includes a component body accommodating portion that accommodates the component body, and terminal accommodating portions that accommodate the end portions of the terminals and the terminal metal fittings, and
a gap dimension between the first terminal and an insertion slot of a first terminal accommodating portion in which the first terminal is accommodated is larger than a gap dimension between the second terminal and an insertion slot of a second terminal accommodating portion in which the second terminal is accommodated.

2. The connection structure of an electronic component and terminal metal fittings according to claim 1, wherein
the plurality of terminals protrude from the component body and bend in right angles.

3. The connection structure of an electronic component and terminal metal fittings according to claim 1, wherein
a width of the second terminal is formed larger than a width of the first terminal.

4. The connection structure of an electronic component and terminal metal fittings according to claim 2, wherein
a width of the second terminal is formed larger than a width of the first terminal.

5. The connection structure of an electronic component and terminal metal fittings according to claim 1, wherein
the second terminal is made of a material that is more rigid than a material of the first terminal.

6. The connection structure of an electronic component and terminal metal fittings according to claim 2, wherein
the second terminal is made of a material that is more rigid than a material of the first terminal.

7. The connection structure of an electronic component and terminal metal fittings according to claim 3, wherein
the second terminal is made of a material that is more rigid than a material of the first terminal.
